(19) United States
(12) Patent Application Publication
(10) Pub. No.: US 2008/0151201 A1
(43) Pub. Date: Jun. 26, 2008

(54) Lithographic apparatus and method

(75) Inventors: Arnoldus Jan Storm, Delft (NL); Johannes Hubertus Josephina Moors, Helmond (NL); Bastiaan Theodoor Wolschrijn, Abcoude (NL); Dirk Heinrich Ehm, Aalen (DE)

Correspondence Address: PILLSBURY WINTHROP SHAW PITTMAN, LLP, P.O. BOX 10500, MCLEAN, VA, 22102, US

(73) Assignees: ASML NETHERLANDS B.V., Veldhoven (NL); CARL ZEISS SMT AG, Oberkochen (DE)

(21) Appl. No.: 11/643,776

(22) Filed: Dec. 22, 2006

(51) Int. Cl. G03B 27/52

(52) U.S. Cl. 355/30

(57) ABSTRACT

A lithographic apparatus that includes an illumination system configured to condition a radiation beam. The illumination system includes a plurality of optical components. The apparatus also includes a support constructed to support a patterning device. The patterning device is capable of imparting the radiation beam with a pattern in its cross-section to form a patterned radiation beam. The apparatus further includes a substrate table constructed to hold a substrate, and a projection system configured to project the patterned radiation beam onto a target portion of the substrate. The projection system includes a plurality of optical components. The apparatus also includes a contamination measurement unit for measuring contamination of a surface of at least one of the optical components. The contamination measurement unit is provided with a radiation sensor constructed and arranged to measure an optical characteristic of radiation received from the surface.

### FIELD

The present invention relates to a lithographic apparatus and a method for measuring contamination within a lithographic apparatus.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. comprising part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned.

To be most effective, the lithographic apparatus is used in an environment as clean as possible. One of the main reasons for using a clean environment is to prevent contamination of the substrate, the patterning device and any optical surfaces which are used to manipulate radiation beams to apply a desired pattern onto the substrate. For example, a lithographic apparatus using an extreme ultraviolet (EUV) radiation beam may generate contaminants which can lead to a deposit forming on the optical surfaces. For example, illumination of some optical surfaces with EUV causes the build up of a carbonaceous deposit on these optical surfaces. These deposits may reduce the operating resolution and the optical transmission of the lithographic apparatus. It is thus desirable to minimize the contamination of optical surfaces and, when necessary, clean the surfaces to remove the deposits. Cleaning of the optical surfaces is undertaken when the level of contamination is such that the operation of the lithographic apparatus may be compromised. Therefore, it is desirable to be able to measure the level of contamination on the optical surfaces of the lithographic apparatus.

### SUMMARY

The present invention provides a contamination measurement unit for measuring the level of contamination on an optical surface of a lithographic apparatus.

According to an aspect of the invention, there is provided a lithographic apparatus that includes an illumination system configured to condition a radiation beam. The illumination system includes a plurality of optical components. The apparatus also includes a support constructed to support a patterning device. The patterning device is capable of imparting the radiation beam with a pattern in its cross-section to form a patterned radiation beam. The apparatus further includes a substrate table constructed to hold a substrate, and a projection system configured to project the patterned radiation beam onto a target portion of the substrate. The projection system includes a plurality of optical components. The apparatus also includes a contamination measurement unit for measuring contamination of a surface of at least one of the optical components. The contamination measurement unit is provided with a radiation sensor constructed and arranged to measure an optical characteristic of radiation received from the surface.

According to an aspect of the invention, there is provided a method of measuring contamination of an optical component within a lithographic apparatus. The method includes directing radiation to a surface of the optical component within the lithographic apparatus, and measuring an optical characteristic from radiation from the surface with a sensor.

According to a further aspect of the invention there is provided an illumination system constructed and arranged for providing a beam of radiation for a lithographic projection apparatus. The illumination system is provided with optical components and a contamination measurement unit for measuring contamination of a surface of at least one of the optical components. The contamination measurement unit is provided with a sensor constructed and arranged to measure an optical characteristic from radiation received from the surface.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 schematically depicts a lithographic apparatus that includes a contamination measurement unit according to an embodiment of the present invention;

FIG. 2 schematically depicts the contamination measurement unit of FIG. 1 in more detail;

FIG. 3 depicts a picture of a clean optical surface; and

FIG. 4 schematically depicts a picture of a contaminated optical surface.

### DETAILED DESCRIPTION

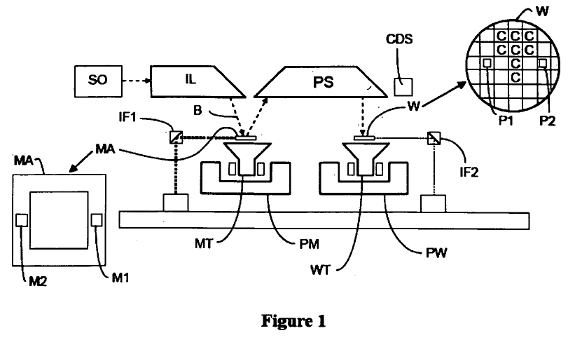

FIG. 1 schematically depicts a lithographic apparatus according to an embodiment of the invention. The apparatus includes: an illumination system (illuminator) IL configured to condition a radiation beam B (e.g. UV radiation or EUV radiation); a support structure (e.g. a mask table) MT constructed to support a patterning device (e.g. a mask) MA and connected to a first positioner PM configured to accurately position the patterning device in accordance with certain parameters; a substrate table (e.g. a wafer table) WT constructed to hold a substrate (e.g. a resist-coated wafer) W and connected to a second positioner PW configured to accurately position the substrate in accordance with certain parameters; a projection system (e.g. a refractive projection lens system) PS configured to project a pattern imparted to the radiation beam B by patterning device MA onto a target portion C (e.g. comprising one or more dies) of the substrate W; and a contamination measurement unit CDS configured to detect contamination of optical surfaces of the lithographic apparatus.

The illumination system may include various types of optical components, such as refractive, reflective or other types of optical components, or any combination thereof, for directing, shaping, or controlling radiation. The optical components may be provided with optical surfaces sensitive to contamination.

The support structure supports, i.e. bears the weight of, the patterning device. It holds the patterning device in a manner that depends on the orientation of the patterning device, the design of the lithographic apparatus, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example, with respect to the projection system. Any use of the terms “reticle” or “mask” herein may be considered synonymous with the more general term “patterning device.”

The term “patterning device” as used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be a transmissive or reflective optical component. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” as used herein should be broadly interpreted as encompassing any type of projection system, including refractive, reflective and catadioptric optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a reflective type (e.g. employing a reflective mask). Alternatively, the apparatus may be of a transmissive type (e.g. employing a transmissive mask).

The lithographic apparatus may be of a type having two (dual stage) or more substrate tables (and/or two or more mask tables). In such “multiple stage” machines, the additional tables may be used in parallel, or preparatory steps may be carried out on one or more tables while one or more other tables are being used for exposure.

The lithographic apparatus may also be of a type wherein at least a portion of the substrate may be covered by a liquid having a relatively high refractive index, e.g. water, so as to fill a space between the projection system and the substrate. An immersion liquid may also be applied to other spaces in the lithographic apparatus, for example, between the mask and the projection system. Immersion techniques are well known in the art for increasing the numerical aperture of projection systems. The term “immersion” as used herein does not mean that a structure, such as a substrate, must be submerged in liquid, but rather only means that liquid is located between the projection system and the substrate during exposure.

It will be appreciated that the term “optical surfaces” used herein should be broadly interpreted as encompassing any surface that radiation is directed at, and in particular optical surfaces used in the conditioning, patterning and projection of the radiation beam B. For example, the optical surfaces may be mirrors, lenses or prisms. The optical surfaces may be transmissive or reflective. A reference optical surface may be one which receives stray light (i.e. an optical surface not in the path of the radiation beam B, but one which receives light reflected (for example) from other surfaces). Properties of the optical surfaces that radiation is directed at may be inferred from properties of the reference optical surface.

Referring to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system comprising, for example, suitable directing mirrors and/or a beam expander. In other cases, the source may be an integral part of the lithographic apparatus, for example when the source is a mercury lamp. The source SO and the illuminator IL, together with the beam delivery system if needed, may be referred to as a radiation system.

The illuminator IL may comprise an adjuster for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may comprise various other components, such as an integrator and a condenser. The illuminator may be used to condition the radiation beam, to have a desired uniformity and intensity distribution in its cross-section.

The radiation beam B is incident on the patterning device (e.g., mask MA), which is held on the support structure (e.g., mask table MT), and is patterned by the patterning device. Having traversed the mask MA, the radiation beam B passes through the projection system PS, which focuses the beam onto a target portion C of the substrate W.

The depicted apparatus could be used in at least one of the following modes:

1. In step mode, the mask table MT and the substrate table WT are kept essentially stationary, while an entire pattern imparted to the radiation beam is projected onto a target portion C at one time (i.e. a single static exposure).

2. In scan mode, the mask table MT and the substrate table WT are scanned synchronously while a pattern imparted to the radiation beam is projected onto a target portion C (i.e. a single dynamic exposure). The velocity and direction of the substrate table WT relative to the mask table MT may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, the mask table MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan.

Contamination of optical surfaces is a problem in lithographic apparatus, and in particular, modern optical lithography, where diffraction-limited imaging is used. This is particularly so in EUV lithography, where carbonaceous deposits will readily form under EUV illumination. The carbonaceous deposits arise because EUV that is incident upon certain optical surfaces (e.g. mirrors) causes electrons to be emitted from the optical surfaces. Typically, these electrons have an energy of between 1 and 50 eV. It is believed that these electrons crack hydrocarbons that are present in the (EUV) lithographic apparatus. These hydrocarbons are present despite the vacuum that exists in a lithographic apparatus, due to (for example) outgassing of components in the apparatus. Over time, these cracked hydrocarbons form a carbonaceous deposit on the optical surfaces of the lithographic apparatus.

It is desirable to measure the amount of carbonaceous deposits, because such deposits may reduce the effectiveness of the optical surfaces (e.g. mirrors) of the lithographic apparatus. The amount of carboneous deposits on the mirrors may depend on the position of the mirror with respect to any contaminant source and may depend on the amount of radiation received. In general, mirrors close to the source (i.e. the mirrors that are the first to receive light from the source) may receive relatively high radiation intensity because every EUV mirror has reflection losses that cause the intensity to be lower further away from the source in the optical column. The deposition of carboneous deposits may therefore be lower further away from the source.

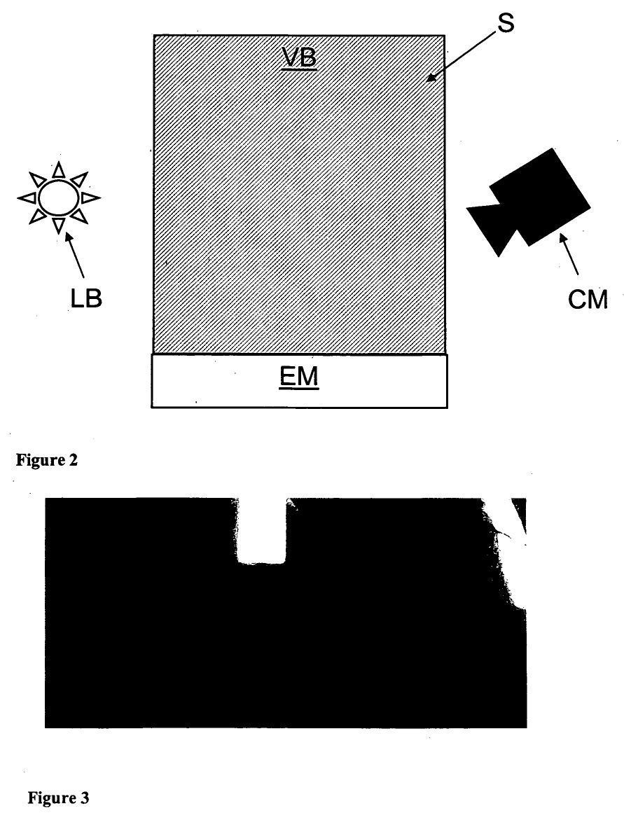

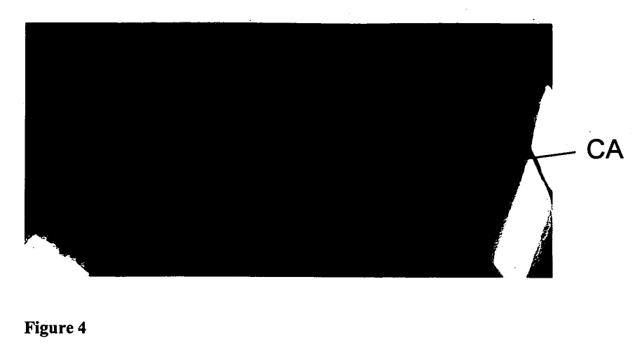

FIG. 2 schematically depicts a contamination measurement unit CDS according to an embodiment of the invention. An EUV mirror EM is subjected to an EUV beam VB, which causes deposition of carboneous contaminants on the optical surface of the mirror EM. By looking with a sensor, such as camera CM, to the reflection caused by the irradiation system (e.g. light source) LB or to light scattered by the contamination from the EUV beam VB, it can estimated whether the optical surface of the mirror EM is contaminated. FIG. 3 is a picture taken from a clean EUV mirror. The mirror EM also works as a reflector in the visible light range, because the picture shows one of the persons working in the cleanroom area where the picture has been taken (see upper left corner of FIG. 3), and shows the lights of the cleanroom being reflected as well. FIG. 4 shows a picture of an EUV mirror after being subjected to EUV radiation and after being contaminated with carboneous deposits. A slightly darker contaminated area CA can be seen on the picture. Tests have estimated that a layer of 30 nm of carboneous deposits have been deposed in the area CA.

The irradiation system LB may be located within or outside the vacuum that is used to allow the EUV radiation to traverse the lithographic apparatus. Outside the vacuum, it is easier to maintain and cool the irradiation system and the radiation may be guided into the vacuum by a fiber. The irradiation system LB may be a light bulb; alternatively it may be a Light Emitting Diode or a diffusive source, for example a white surface that is indirectly illuminated. The irradiation system LB may be combined with the sensor (e.g. camera) for a compact design and may be positioned inside or outside the vacuum. The irradiation system LB may be irradiating light with a wavelength that is particularly sensitive to absorption by carboneous deposits. The irradiation system LB may radiate infrared radiation with a wavelength between 750 nm and 1 mm or ultraviolet radiation with a wavelength smaller than 380 e.g. radiation between 200 and 300 nm. Visible light with a wavelength between 400 and 700 nm may also be used. The angle of incidence may also be chosen such that the absorption or scattering by carboneous deposits causes maximum contrast on the camera CM.

The irradiation system LB may be constructed and arranged with respect to the camera CM and the mirror EM such that the irradiation system LB reflects into the camera. Contamination on the mirror in this case will cause the camera to receive less light.

As an alternative, the illumination system that provides the EUV radiation to the lithographic apparatus may be used for the measurement of contamination. In FIG. 2, a space S is reserved for reflection of the EUV radiation beam on the mirror EM. If the mirror gets contaminated the contamination may scatter the EUV radiation in the direction outside the space S into the direction of the sensor (e.g. camera) CM. Contamination in this case will cause the camera CM to receive more radiation. An advantage of this alternative may be that no additional irradiation system LB is necessary for the contamination measurement unit.

The sensor (e.g. camera) CM may be located within or outside the vacuum. The later being advantageous for maintenance and cooling of the camera. With the camera outside the vacuum, fibers may be used to transfer the image through the vacuum wall. Locating the camera CM within the vacuum has the advantage that it is easier to put it close to the mirror, which may improve the resolution of the images that can be made of the mirror. The camera may be a two-dimensional CCD array that gives a two dimensional image of the spread of the contamination on the mirror. The information on the spread of the contamination can be used to adjust the cleaning locally such that heavily contaminated areas are more intensively cleaned than less contaminated areas. The cleaning may be done by scanning an atomic hydrogen generator (e.g. a hot wire in a flow of hydrogen gas) over the contaminated surface. By adjusting the scanning speed to the level of carboneous contamination on a particular area, the cleaning result and the cleaning speed can be improved, while at the same time too much cleaning at a certain position that may cause damage to the mirror may be avoided. The cleaning may also be done by a fixed atomic hydrogen generator. The camera CM may also give information on the progress of the cleaning and may be used to trigger the stop of the cleaning. The inspection of the mirror may be automated such that the image of a clean mirror is stored in the system and automatically compared with the actual image of the mirror. If the transmission is below a certain threshold value, the cleaning may then be initiated automatically or an alarming signal may be sent to an operator. The source output may also be adjusted to compensate for the loss of transmission. The mirror may also be cleaned by multiple atomic hydrogen generators for improving uniformity of the cleaning result. The camera may then be used to dictate which atomic hydrogen generator needs to be used and to trigger the stop of the cleaning per atomic hydrogen generator.

For determining how thick the layer of contaminants is in relation to a certain amount of transmission of the mirror EM, the contamination measurement unit may be calculated by measuring the transmission and then determining the thickness of the layer of contamination with, for example, a scanning electron microscope. If the steps of measuring the transmission and determining the layer thickness of contaminants is repeated a couple of times, the relation between the layer thickness and the transmission may be established so that measuring the transmission provides the layer thickness.

To make the contamination measurement unit more robust against variation of the radiation intensity of the irradiation system, a mirror that is outside the EUV radiation beam VB, B may be introduced and may not be contaminated. The sensor may measure a difference in radiation from (the part of) the mirror that is illuminated with EUV and (the part of) the mirror that is not illuminated with EUV.

Measuring of the radiation with the sensor may comprise measuring the intensity of the radiation or it may comprise measuring the intensity per wavelength. Carboneous contamination may, for example, absorb radiation with a certain wavelength very effectively. Measuring at this certain wavelength may make the sensor very sensitive. For this purpose, the contamination measurement unit may be provided with a filter so as to improve the sensitivity. The filter may be provided to the illumination system or to the sensor.

It is advantageous to locate the contamination measurement unit CDS close to the first mirrors in the illumination system of the lithographic apparatus, because these mirrors are close to the source and therefore receive a high intensity of radiation. The high intensity of radiation tends to cause the mirror to contaminate more quickly. The source also may be a source of contamination and these mirrors may therefore be the mirrors that contaminate the fastest. It may also be advantageous to provide the contamination measurement unit close to the substrate table, because the substrate, and especially the resist provided on the substrate, may be another source of contaminants.

The embodiments of the invention are suited for use in optical lithographic apparatus that use EUV radiation to expose substrates (the EUV radiation causes the build-up of carbonaceous deposits on optical surfaces in the lithographic apparatus). The embodiments of the invention may, however, be used to measure the level of contamination on optical surfaces in lithographic apparatus in general, i.e. not just contamination arising due to EUV radiation. Furthermore, the contamination need not be carbonaceous deposits or other inorganic materials. The contamination may consist of heavy hydrocarbons generated from vacuum and resist outgassing. Further, the effects of the EUV source on the first collector mirror might be monitored by the contamination measurement unit according to the invention (deposition of source material, e.g. Sn, in layer and/or droplets).

A maximum level of contamination to be allowed on an optical surface before cleaning may be started may be about 16 nanometers. It will be appreciated that this level is only an example, and that the maximum desired level may be higher or lower than 16 nanometers. Other factors which may be taken into account include the concentration of the contamination, the nature of the optical surface, and/or the nature or type of contamination.

As described above, the contamination measurement unit CDS is located such that it is exposed to stray radiation (the contamination measurement unit CDS is not located in the path of the radiation beam B used to expose the substrate). It will be appreciated that the contamination measurement unit CDS may be provided at one of a number of locations in the lithographic apparatus, and that this location may vary according to the exact layout of the lithographic apparatus and its constituent parts. In some instances, it may be possible to position a contamination measurement unit such that it measures contamination on a surface that is located in the path of the radiation beam VB by scattering of the light that comes from the source used for exposure of substrates.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool.

While specific embodiments of the invention have been described above, it will be appreciated that the invention may be practiced otherwise than as described.

The descriptions above are intended to be illustrative, not limiting. Thus, it will be apparent to one skilled in the art that modifications may be made to the invention as described without departing from the scope of the claims set out below.

What is claimed is:

1. A lithographic apparatus comprising:
an illumination system configured to condition a radiation beam, the illumination system comprising a plurality of optical components;
a support constructed to support a patterning device, the patterning device being capable of imparting the radiation beam with a pattern in its cross-section to form a patterned radiation beam;
a substrate table constructed to hold a substrate; and
a projection system configured to project the patterned radiation beam onto a target portion of the substrate, the projection system comprising a plurality of optical components; and
a contamination measurement unit for measuring contamination of a surface of at least one of the optical components, the contamination measurement unit being provided with a radiation sensor constructed and arranged to measure an optical characteristic of radiation received from the surface.

2. The lithographic apparatus according to claim 1, wherein the sensor comprises a camera for making two dimensional images of the surface.

3. The lithographic apparatus according to claim 2, wherein the camera comprises a CCD array.

4. The lithographic apparatus according to claim 1, wherein the contamination measurement unit is constructed and arranged to measure contamination on one of the first three surfaces on which radiation reflects in the illumination system.

5. The lithographic apparatus according to claim 1, wherein the contamination measurement unit comprises an irradiation system for irradiation of the surface independent of the illumination system.

6. The lithographic apparatus according to claim 5, wherein the irradiation system, the optical component and the sensor are constructed and arranged so that the sensor receives radiation reflected by the surface from the irradiation system.

7. The lithographic apparatus according to claim 5, wherein the irradiation system comprises a light bulb.

8. The lithographic apparatus according to claim 5, wherein the irradiation system comprises a light emitting diode.

9. The lithographic apparatus according to claim 5, wherein the irradiation system radiates radiation of a laser.

10. The lithographic apparatus according to claim 5, wherein the irradiation system radiates radiation of an infrared source with a wavelength between 700 nm and 1 mm.

11. The lithographic apparatus according to claim 5, further comprising a vacuum wall for creating a vacuum beam path for the radiation beam, and wherein the contamination measurement unit is provided with a fiber for guiding radiation from outside the vacuum wall to the irradiation system.

12. The lithographic apparatus according to claim 1, further comprising a processor and a memory constructed and arranged to store an optical characteristic of the radiation received by the sensor from the surface and to compare the stored measurement by with a present measurement of the radiation received by the sensor from the surface to generate a comparative signal.

13. The lithographic apparatus according to claim 12, wherein the memory is constructed and arranged to store a threshold value and the processor is constructed and arranged to compare the comparative signal with the threshold value so as to generate a signal for indicating that cleaning is necessary when the comparative signal exceeds the threshold value.

14. The lithographic apparatus according to claim 12, wherein the processor is constructed and arranged to process a comparative signal as a function of the position on the surface.

15. The lithographic apparatus according to claim 1, wherein the sensor is constructed and arranged to measure optical characteristics of infrared radiation with a wavelength between 700 nm and 1 mm.

16. The lithographic apparatus according to claim 1, wherein the sensor is constructed and arranged to detect extreme ultraviolet radiation that is scattered from the surface.

17. The lithographic apparatus according to claim 1, wherein the sensor is constructed and arranged to measure intensity of radiation.

18. The lithographic apparatus according to claim 1, wherein the sensor is constructed and arranged to measure intensity per wavelength of the radiation.

19. A method of measuring contamination of an optical component within a lithographic apparatus, the method comprising:
directing radiation to a surface of the optical component within the lithographic apparatus; and
measuring an optical characteristic from radiation from the surface with a sensor.

20. The method according to claim 19, wherein the radiation is reflected from the surface.

21. The method according to claim 19, wherein the radiation is scattered from the surface.

22. An illumination system constructed and arranged for providing a beam of radiation for a lithographic projection apparatus, the illumination system being provided with optical components and a contamination measurement unit for measuring contamination of a surface of at least one of the optical components, the contamination measurement unit being provided with a sensor constructed and arranged to measure an optical characteristic from radiation received from the surface.
